(19) United States
(12) Patent Application Publication
(10) Pub. No.: US 2012/0129756 A1
(43) Pub. Date: May 24, 2012

(54) Dilutable cleaning compositions and methods for use

(75) Inventors: Amit Sehgal, Marlton, NJ (US); Sophie Deroo, I'Hay les Roses (FR); Satyen Trivedi, East Windsor, NJ (US); Ruela Talingting Pabalan, Burlington, NJ (US); David Fluck, Elkton, MD (US); Charles Aymes, Monmouth Junction, NJ (US)

(73) Assignee: RHODIA OPERATIONS, Cranbury, NJ (US)

(21) Appl. No.: 13/373,628

(22) Filed: Nov. 22, 2011

Related U.S. Application Data
(60) Provisional application No. 61/458,341, filed on Nov. 22, 2010.

(51) Int. Cl. C11D 17/00; C11D 3/60

(52) U.S. Cl. 510/417; 510/505; 510/506

(57) ABSTRACT

An environmentally-friendly, low VOC cleaning composition for industrial and consumer applications comprising (a) a blend of dibasic esters, (b) one or more nonionic surfactants (c) and, optionally, (d) water or a solvent. The dibasic esters are be derived from a blend of adipic, glutaric, and succinic diacids, and, in one particular embodiment, the blend comprises dialkyl adipate, dialkyl methylglutarate and dialkyl ethylsuccinate, wherein the alkyl groups individually comprise a C₁-C₁₂ hydrocarbon group. The cleaning composition is in the form of a microemulsion when mixed in water and is dilutable with water by an amount of at least 99 parts water to 1 part said cleaning composition without phase separation.

### CROSS-REFERENCE TO RELATED APPLICATION

This application claims the benefit of U.S. Provisional Application Ser. No. 61/458,341, filed Nov. 22, 2010, herein incorporated by reference.

### FIELD OF THE INVENTION

This invention relates to cleaning compositions that are environmentally friendly, biodegradable, non-toxic and non-flammable with low odor, low vapor pressure and low volatile organic compound (VOC) content and, more particularly, cleaning compositions that are infinitely or extremely dilutable from a concentrate (with less than 1 part water to 99 parts active) to a diluted form with at least 99 parts water to 1 part composition without phase separation.

### BACKGROUND OF THE INVENTION

Many commercially available cleaners incorporate environmentally hazardous and toxic volatile organic compounds (VOCs). It has been found that VOCs are linked to ground level ozone formation and contribute significantly to other health hazards. For example, many cleaning solutions contain high VOC solvents include toluene, xylene, methyl ethyl ketone, glycol ethers, tetrachloroethylene, methyl isobutyl ketone, methanol, 1,1,1-trichloroethane, dichloromethane and ethylene glycol. Many cleaning compositions contain aromatic compounds that are in many cases hazardous air pollutants (HAPs) or are not environmentally friendly in that they are not biodegradable and are eco-toxins. Often these solvents have low flashpoints that make them extremely flammable. Such compositions are undesirable in light of the increased awareness for human exposure to toxic materials and the demand for environmentally friendly, non-toxic solvents. However, the drawbacks in utilizing these solvents have not diminished their use due to perceived performance.

Performance-in-application is therefore critical for the successful adoption of environmentally preferable technologies in the marketplace. Consequently, there is also a need to develop improved cleaning compositions and methods of use that are environmentally friendly without compromising effectiveness in various industrial and consumer cleaning applications.

Low vapor pressure solvents that are environmentally benign and have the appropriate solvency can offer alternatives to VOC or HAPs solvents. However, such low vapor pressure/VOC solvents also present the problem that the solvent does not vaporize and may leave residual solvent on the surface being cleaned which may not be acceptable for some applications. To address this issue, cleaning compositions containing these low VOC solvents are typically emulsions and contain water or are rinsed with water to remove the excess solvent.

Further, many cleaning emulsions based on these low vapor pressure solvents are unstable by their very nature. Phase separation may occur during storage, upon dilution of the cleaning compositions, either to make a commercial product (e.g., for retail sale) from an industrially-sold concentrate or when rinsing off the applied cleaning solution from a surface desired to be cleaned or a combination of all. Phase separation may substantially diminish the cleaning capability of the diluted cleaning composition especially for solvents/soils that are denser than water. The solubilized contaminants (e.g., dirt, heavy grease) as well as the solvent itself can remain on the substrate to be cleaned. Thus, what is needed is an environmentally friendly, low VOC, readily biodegradable and/or non-toxic cleaning composition that is intrinsically stable upon dilution and suitable for the treatment and cleaning of soiled or contaminated substrates and the like.

### SUMMARY OF THE INVENTION

This invention utilizes dibasic esters as solvents in cleaning compositions as high performance, environmentally preferable alternatives to hazardous solvents commonly used in cleaning applications. The solvents described herein also present an improved Health, Safety, and Environmental (HSE) profile. They are readily biodegradable, non-flammable (with high flash points), non-toxic, non-irritant and non-sensitizers. They also have a very low vapor pressure (non-VOC per CARB 310 and EU 1999/13/EC), and high boiling points while maintaining low viscosities. They have a very mild/neutral odor. As there is a push for environmentally-friendly or “green” solutions, these properties of the solvents described make them attractive for applications ranging from home and personal care, to institutional cleaners, or for industrial processes where safety and is paramount. However, as discussed above, such low vapor pressure/VOC green solvents also present the problem that the solvent does not vaporize and may leave residual solvent on the surface being cleaned which may not be acceptable for some applications.

As described in greater detail herein, microemulsions are thermodynamically stable and clear emulsions as opposed to milky unstable emulsions which require agitation to maintain the oil phase in water. The compositions and methods described herein address the problem by using aqueous microemulsions of diester solvents that are infinitely or extremely dilutable without phase separation and provide a mechanism for efficient delivery and removal of dibasic ester solvents from the substrate.

The present invention will become apparent from the following detailed description and examples, which comprises in one aspect, an infinitely dilutable cleaning composition comprising one or more dibasic esters; one or more non-ionic surfactants; and, optionally, additional components and/or water. The dibasic esters can be derived from adipic, glutaric, and succinic diacids, or isomers thereof. In one particular embodiment, the dibasic ester blend is comprised of a mixture dialkyl methylglutarate, dialkyl ethylsuccinate and, optionally, dialkyl adipate, where the alkyl groups individually comprise C₁-C₁₂ hydrocarbon groups. In another particular embodiment, the dibasic ester blend is comprised of a mixture dialkyl glutarate, dialkyl succinate and dialkyl adipate, where the alkyl groups individually comprise C₁-C₁₂ hydrocarbon groups.

In one aspect, the present invention is an infinitely dilutable cleaning composition comprising, based on the total weight of the composition: (a) from about 1% to about 60% by weight a blend of dibasic esters; (b) from about 0.1% to about 65% by weight one or more non-ionic surfactants; and, optionally, (c) water.

In one aspect, described herein is an environmentally-friendly, readily biodegradable, low VOC cleaning composition comprising: (a) a blend of dibasic esters selected from the group consisting of dialkyl methylglutarate, dialkyl adipate, dialkyl ethylsuccinate, dialkyl succinate, dialkyl glutarate and any combination thereof; and (b) at least one nonionic surfactant, wherein the solvent blend:surfactant ratio is less than or equal to about 2.3:1, respectively, (in some embodiments, the solvent blend:surfactant ratio is less than or equal to about 2:1, the solvent blend:surfactant ratio is less than or equal to about 1.6:1 in other embodiment, in further embodiments, less than or equal to about 1.2:1, in yet other embodiments, less than or equal to about 0.8:1) wherein the cleaning composition is in the form of a microemulsion when mixed in water and is dilutable with water by an amount of at least 99 parts water to 1 part said cleaning composition without phase separation. It is understood in some embodiments where the solvent blend:surfactant ratio is described as being, for example, less than or equal to about 1.6 or 1.6:1 (used interchangeably) means the amount by weight of solvent blend is 1.6 parts relative to 1 part of surfactant. In one embodiment, the blend of dibasic esters comprises dialkyl methylglutarate, dialkyl adipate, dialkyl ethylsuccinate. In another embodiment, the blend of dibasic esters comprises dialkyl methylglutarate, dialkyl ethylsuccinate. In another embodiment, the blend of dibasic esters comprises dialkyl methylglutarate, dialkyl adipate, dialkyl ethylsuccinate, dialkyl succinate and dialkyl glutarate.

The cleaning composition can further optionally comprise water, in some embodiments. In one such particular embodiment, the cleaning composition comprises: (a) a blend of dibasic esters selected from the group consisting of dialkyl methylglutarate, dialkyl adipate, dialkyl ethylsuccinate, dialkyl succinate, dialkyl glutarate and any combination thereof; (b) at least one nonionic surfactant, wherein the solvent blend:surfactant ratio is less than or equal to about 2.5:1, or 2:1, or 1.6:1 or 1.2:1 or 1:1, or 0.8:1; and (c) from about 1% to about 99%, by weight of the composition, of water; wherein the cleaning composition is in the form of a microemulsion and is dilutable with water by an amount of at least 99 parts water to 1 part said cleaning composition without phase separation.

In one embodiment, the blend of dibasic esters comprises (i) a dialkyl methylglutarate and (ii) at least one of a dialkyl adipate or a dialkyl ethylsuccinate. In another embodiment, blend of dibasic esters comprises dialkyl adipate, dialkyl methylglutarate and dialkyl ethylsuccinate. The solvent blend:surfactant ratio can be less than or equal to about 0.9. The solvent blend:surfactant ratio can be less than or equal to about 0.6, in other embodiments.

In one embodiment, the non-ionic surfactant can be one or more branched alcohol alkoxylates, one or more linear alcohol alkoxylates or a combination of at least one branched alcohol alkoxylate and at least one linear alcohol alkoxylate.

In one embodiment, the non-ionic surfactant is at least one branched C₅-C₂₀ alcohol butoxylate, at least one linear C₅-C₂₀ alcohol butoxylate, at least one branched C₅-C₂₀ alcohol propoxylate, at least one linear C₅-C₂₀ alcohol propoxylate, at least one branched C₅-C₂₀ alcohol ethoxylate, at least one linear C₅-C₂₀ alcohol ethoxylate and any combination thereof.

In another embodiment, the non-ionic surfactant has formula:

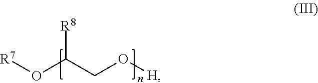

wherein R⁷ is a hydrogen or a branched hydrocarbon chain containing from about 5 to about 25 carbon atoms, R⁸ is a hydrogen or a hydrocarbon chain containing from about 1 to about 5 carbon atoms; “n” is an integer from about 1 to about 30.

In one embodiment, the blend of dibasic esters comprises:

(i) from about 5-25%, by weight of the blend, a first dibasic ester of formula:

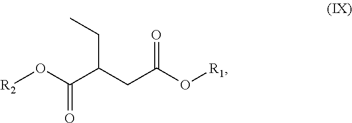

(ii) from about 70-95%, by weight of the blend, a second dibasic ester of formula:

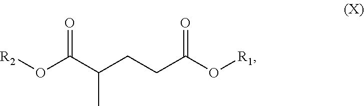

and, optionally,

(iii) from about 0-5%, by weight of the blend, a third dibasic ester of formula:

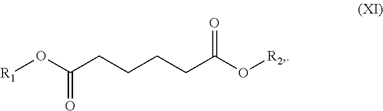

wherein R₁ and R₂ are hydrocarbon groups individually selected methyl, ethyl, propyl, isopropyl, n-butyl, pentyl, isoamyl, hexyl, heptyl or octyl. In another embodiment, R₁ and R₂ are individually selected from branched, linear and/or cyclic C₁-C₁₀ hydrocarbon groups.

In one embodiment, the blend of dibasic esters is characterized by vapor pressure of less than about 10 Pa.

In one embodiment, the blend of dibasic esters comprises:

(i) from about 20-28%, by weight of the blend, a first dibasic ester of formula:

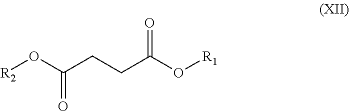

(ii) from about 59-67%, by weight of the blend, a second dibasic ester of formula:

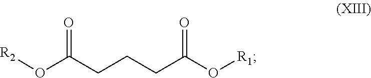

and

(iii) from about 9-17%, by weight of the blend, a third dibasic ester of formula:

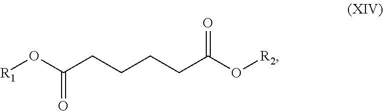

wherein R₁ and R₂ are hydrocarbon groups individually selected from methyl, ethyl, propyl, isopropyl, n-butyl, pentyl, isoamyl, hexyl, heptyl or octyl. In another embodiment, R₁ and R₂ are individually selected from branched, linear and/or cyclic C₁-C₁₀ hydrocarbon groups.

In one particular embodiment, described herein are environmentally-friendly, readily biodegradable, low VOC cleaning composition comprising: (a) a blend of dibasic esters selected from the group consisting of dialkyl methylglutarate, dialkyl adipate, dialkyl ethylsuccinate, dialkyl succinate, dialkyl glutarate and any combination thereof; (b) a co-solvent; (c) at least one nonionic surfactant. In some embodiments, the solvent blend:surfactant ratio (by weight) is less than or equal to about 2.3, in other embodiments, the solvent blend:surfactant ratio (by weight) is less than or equal to about 2. In some embodiments, the cleaning composition is in the form of a microemulsion when mixed in water and is dilutable with water by an amount of at least 99 parts water to 1 part said cleaning composition without phase separation.

The one or more co-solvents that can be included in said cleaning composition embodiment include, but are not limited to, saturated hydrocarbon solvents, glycol ethers, fatty acid methyl esters, aliphatic hydrocarbons solvents, acyclic hydrocarbons solvents, halogenated solvents, aromatic hydrocarbon solvents, cyclic terpenes, unsaturated hydrocarbon solvents, halocarbon solvents, polyols, ethers, glycol esters, alcohols, ketones, and any combination thereof. The addition of such a co-solvent can cause the solvent blend:surfactant ratio in the composition to increase.

In one embodiment, the cleaning composition can include one or more additives selected from delaminates, buffering agents, fragrances, perfumes, defoamers, dyes, whiteners, brighteners, solubilizing materials, stabilizers, thickeners, corrosion inhibitors, lotions, mineral oils, enzymes, cloud point modifiers, particles, preservatives, ion exchangers, chelating agents, sudsing control agents, soil removal agents, softening agents, opacifiers, inert diluents, graying inhibitors, stabilizers, polymers or any combination thereof.

In one embodiment, the blend of dibasic esters is present in an amount from about 1% to about 40% by weight of the cleaning composition, and at least one nonionic surfactant is present in an amount greater than about 50% by weight of the cleaning composition.

In one embodiment, the cleaning composition can further comprise at least one co-surfactant. In another embodiment, cleaning composition is diluted with water by an amount of at least 99 parts water to 1 part of said cleaning composition.

In another aspect, described herein are infinitely dilutable, environmentally-friendly, biodegradable, low VOC cleaning compositions comprising:

(a) from about 1% to about 50% by weight of the composition, a blend of dibasic esters comprising:

(i) from about 5-25%, by weight of the blend, a first dibasic ester of formula:

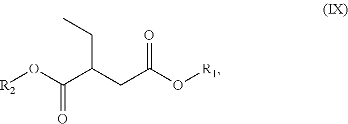

(ii) from about 70-95%, by weight of the blend, a second dibasic ester of formula:

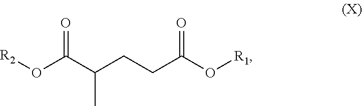

and

(iii) from about 0-5%, by weight of the blend, a third dibasic ester of formula:

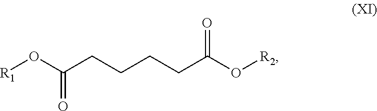

wherein R₁ and R₂ are individually selected from C₁-C₉ hydrocarbon groups, which can be branched, linear or cyclic (in some embodiments, R₁ and R₂ are hydrocarbon groups individually selected from methyl, ethyl, propyl, isopropyl, n-butyl, pentyl, isoamyl, hexyl, cyclohexyl, heptyl or octyl);

(b) greater than about 50%, by weight of the composition, of at least one nonionic surfactant of formula:

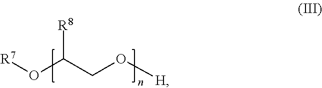

wherein R⁷ is a hydrogen or a branched hydrocarbon chain containing from about 5 to about 25 carbon atoms, R⁸ is a hydrogen or a hydrocarbon chain containing from about 1 to about 5 carbon atoms; “n” is an integer from about 1 to about 30, more typically an integer from 2 to about 20, and most typically an integer from about 3 to about 12;

wherein the solvent blend:surfactant ratio (by weight) is less than or equal to about 1, in one embodiment, or 0.8 in another embodiment; and

(c) from about 0.05 to about 5%, by weight of the composition, of water;

wherein the cleaning composition is in the form of a microemulsion and is dilutable with water by an amount of at least 99 parts water to 1 part said cleaning composition without phase separation.

In yet in another aspect, described herein are methods of cleaning a surface comprising: (a) providing any of the cleaning compositions described herein; (b) diluting the cleaning composition by an amount equal to or greater than 99 parts water to 1 part cleaning composition; (b) contacting the cleaning composition with a surface having one or more contaminants on it; and (c) removing the used cleaning composition from the surface.

In another aspect, described herein are methods of cleaning surfaces comprising: (a) providing any of the cleaning compositions described herein; (b) contacting the cleaning composition with a surface having one or more contaminants on it; and (c) removing the used cleaning composition from the surface.

In a further aspect, described herein are methods of cleaning surfaces comprising: (a) providing any of the cleaning compositions described herein that are diluted with in an amount from about 1% to about 99%, by weight of the composition, of water; (b) contacting the cleaning composition with a surface having one or more contaminants on it; and (c) removing the used cleaning composition from the surface.

The cleaning composition of the present invention is environmentally friendly, with a high flash point, low vapor pressure and low odor; it falls under the consumer products LVP-VOC exemption criteria established by CARB and the EPA (CARB 310 and EU 1999/13/EC). The cleaning formulation of the present invention has environmentally friendly characteristics including but not limited to being non toxic, bio-degradable, non-flammable and the like.

### BRIEF DESCRIPTION OF FIGURES

FIG. 1 is PHOTOGRAPH illustrating the ternary phase of IRIS-Rhodasurf DA-630-H₂O.

FIG. 2 shows ternary phase diagrams of Rhodiasolv IRIS-Rhodasurf 91-6-H₂O (linear surfactant) compared with Rhodiasolv IRIS-Rhodasurf DA630-H₂O (branched surfactant).

FIG. 3 shows ternary phase diagrams of Rhodiasolv RPDE-Rhodasurf 91-6-H₂O (linear surfactant) compared with Rhodiasolv RPDE-Rhodasurf DA630-H₂O (branched surfactant).

FIG. 4 shows ternary phase diagrams of Rhodiasolv RPDE-Rhodasurf LA7-H2O (linear surfactant) compared with Rhodiasolv RPDE-Rhodasurf TDA-8/5-H2O (branched surfactant).

FIG. 5 shows ternary phase diagrams of Rhodiasolv DEE-Rhodasurf 91-6-H2O (linear surfactant) compared with Rhodiasolv DEE-Rhodasurf DA630-H2O (branched surfactant)

### DETAILED DESCRIPTION

As used herein, the term “alkyl” means a saturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the terminology “(Cᵣ—Cₛ)” in reference to an organic group, wherein r and s are each integers, indicates that the group may contain from r carbon atoms to s carbon atoms per group.

As used herein, the terminology “surfactant” means a compound that when dissolved in an aqueous medium lowers the surface tension of the aqueous medium.

The cleaning composition of the present invention has desirable qualities including one or a combination of being: substantially non-toxic, non-flammable, readily biodegradable, high flash point, low vapor pressure and low odor; meets the consumer products LVP-VOC exemption criteria established by CARB and the EPA, such as CARB 310 and the EU 1999/13/EC.

Infinitely dilutable microemulsions of dibasic esters with an improved mechanism to deliver these eco-friendly solvents for cleaning applications. Some infinitely dilutable microemulsions described herein are blends with non-ionic alcohol ethoxylate surfactants as biodegradable environmentally friendly formulations. The blends are free of APE (alcohol phenol ethoxylates) or non-degradable anionics such as isopropylamine salts of alkyl benzene sulfonic acids that are described in prior art. According to the recently published HERA (Human & Environmental Risk Assessment on ingredients of European household cleaning products) in September 2009, “AE (alcohol ethoxylate) usage in laundry cleaners and household cleaning products is not a cause for concern in the EU environment, as shown by consideration of surface water, sediment, sewage treatment facilities, and soil.”

In some aspect, the use of branched alcohol ethoxylates is more efficient (i.e., less amounts needed) as compared to linear homologues in formulating infinitely dilutable concentrates of dibasic esters. The HERA report also outlines that “acute effects data is available for branched AE which establishes that they are not more toxic than the linear AEs with the same number of carbon atoms in the hydrocarbon chain”.

Non-ionic surfactants are less susceptible to water hardness compared to the ionic counterparts. They are also readily soluble in organic solvents in the concentrate compared to anionic surfactants. This allows formulation concentrates with very little water (generally, in amounts less than about 10%, typically less than about 5% or 4% or 3%, more typically less than about 1%) which is especially advantageous for improved storage stability of dibasic ester concentrates. Use of predominantly nonionic surfactants may also result in lower electrical conductivity of the formulation which is suitable for use in cleaning electronics or electrical equipment.

The infinitely dilutable concentrates of formulations of dibasic esters with branched alcohol ethoxylates allow easy dilution to the desired actives concentration in use forming stable clear emulsions. Depending on the added water content the solution structure may transition from water-in-oil, to co-continuous water-in-oil, to co-continuous oil-in-water, to nanoscale oil droplets in water. The formulations containing dibasic esters are “infinitely dilutable” since they are partially soluble in water. The term “infinitely dilutable” as used herein means that the cleaning compositions described can be diluted to at least 50 parts water to 1 part cleaning composition (by weight), typically to at least 99 parts water to 1 part cleaning composition, or, in other embodiment, to at least 150 parts water to 1 part cleaning composition, without separating into two or more phases, i.e., remains in a single-phase. The environmentally-friendly cleaning compositions as described herein are thermodynamically stable as microemulsions and are in a single-phase.

Dilutions greater than 80% (by weight of the composition, with water) are possible with an increasing fraction of the solvent partitioning into the aqueous phase from the emulsion droplet. An entire gamut of formulations and applications are hence possible along this continuous dilution line.

Described herein are infinitely dilutable cleaning composition comprising a blend of dibasic esters. In one embodiment, the blend comprises adducts of alcohol and linear diacids, the adducts having the formula R₁—OOC-A-COO—R₂ wherein R₁ and/or R₂ comprise, individually, a C₁-C₁₂ alkyl, more typically a C₁-C₈ alkyl, and A comprises a mixture of —(CH₂)₄—, —(CH₂)₃, and —(CH₂)₂—. In another embodiment, R₁ and/or R₂ comprise, individually, a C₄-C₁₂ alkyl, more typically a C₄-C₈ alkyl. In one embodiment, R₁ and R₂ can individually comprise a hydrocarbon group originating from fusel oil. In one embodiment, R₁ and R₂ individually can comprise a hydrocarbon group having 1 to 8 carbon atoms. In one embodiment, R₁ and R₂ individually can comprise a hydrocarbon group having 5 to 8 carbon atoms.

In one embodiment, the blend comprises adducts of alcohol and branched or linear diacids, the adducts having the formula R1-OOC-A-COO—R2 wherein R1 and/or R2 comprise, individually, a C1-C12 alkyl, more typically a C1-C8 alkyl, and A comprises a mixture of —(CH2)4-, —CH2CH2CH(CH3)-, and —CH2CH(C2H5)-. In another embodiment, R1 and/or R2 comprise, individually, a C4-C12 alkyl, more typically a C4-C8 alkyl. It is understood that the acid portion may be derived from such dibasic acids such as adipic, succinic, glutaric, oxalic, malonic, pimelic, suberic and azelaic acids, as well as mixtures thereof.

One or more dibasic esters used in the present invention can be prepared by any appropriate process. For example, a process for preparing the adduct of adipic acid and of fusel oil is, for example, described in the document “The Use of Egyptian Fusel Oil for the Preparation of Some Plasticizers Compatible with Polyvinyl Chloride”, Chuiba et al., Indian Journal of Technology, Vol. 23, August 1985, pp. 309-311.

The dibasic esters of the present invention can be obtained by a process comprising an “esterification” stage by reaction of a diacid of formula HOOC-A-COOH or of a diester of formula MeOOC-A-COOMe with a branched alcohol or a mixture of alcohols. The reactions can be appropriately catalyzed. Use is preferably made of at least 2 molar equivalents of alcohols per diacid or diester. The reactions can, if appropriate, be promoted by extraction of the reaction by-products and followed by stages of filtration and/or of purification, for example by distillation.

The diacids in the form of mixtures can in particular be obtained from a mixture of dinitrile compounds in particular produced and recovered in the process for the manufacture of adiponitrile by double hydrocyanation of butadiene. This process, used on a large scale industrially to produce the greater majority of the adiponitrile consumed worldwide, is described in numerous patents and works. The reaction for the hydrocyanation of butadiene results predominantly in the formulation of linear dinitriles but also in formation of branched dinitriles, the two main ones of which are methylglutaronitrile and ethylsuccinonitrile. The branched dinitrile compounds are separated by distillation and recovered, for example, as top fraction in a distillation column, in the stages for separation and purification of the adiponitrile. The branched dinitriles can subsequently be converted to diacids or diesters (either to light diesters, for a subsequent transesterification reaction with the alcohol or the mixture of alcohols or the fusel oil, or directly to diesters in accordance with the invention). For example, the blend of dibasic esters is derived or taken from the methylglutaronitrile product stream in the manufacture of adiponitrile.

Dibasic esters of the present invention may be derived from one or more by-products in the production of polyamide, for example, polyamide 6,6. In one embodiment, the cleaning composition comprises a blend of linear or branched, cyclic or noncyclic, C₁-C₂₀ alkyl, aryl, alkylaryl or arylalkyl esters of adipic diacids, glutaric diacids, and succinic diacids. In another embodiment, the cleaning composition comprises a blend of linear or branched, cyclic or noncyclic, C₁-C₂₀ alkyl, aryl, alkylaryl or arylalkyl esters of adipic diacids, methylglutaric diacids, and ethylsuccinic diacids

Generally, polyamide is a copolymer prepared by a condensation reaction formed by reacting a diamine and a dicarboxylic acid. Specifically, polyamide 6,6 is a copolymer prepared by a condensation reaction formed by reacting a diamine, typically hexamethylenediamine, with a dicarboxylic acid, typically adipic acid.

In one embodiment, the blend of the present invention can be derived from one or more by-products in the reaction, synthesis and/or production of adipic acid utilized in the production of polyamide, the cleaning composition comprising a blend of dialkyl esters of adipic diacids, glutaric diacids, and succinic diacids (herein referred to sometimes as “AGS” or the “AGS blend”). In one embodiment, the blend of esters is derived from by-products in the reaction, synthesis and/or production of hexamethylenediamine utilized in the production of polyamide, typically polyamide 6,6.). In one embodiment, the blend of dibasic esters is derived or taken from the methylglutaronitrile product stream in the manufacture of adiponitrile; the cleaning composition comprises a blend of dialkyl esters of methylglutaric diacids, ethylsuccinic diacids and, optionally, adipic diacids (herein referred to sometimes as “MGA”, “MGN”, “MGN blend” or “MGA blend”).

The boiling point of the dibasic ester blend of the present invention is between the range of about 120° C. to 450° C. In one embodiment, the boiling point of the blend of the present invention is in the range of about 160° C. to 400° C.; in one embodiment, the range is about 210° C. to 290° C.; in another embodiment, the range is about 210° C. to 245° C.; in another embodiment, the range is the range is about 215° C. to 225° C. In one embodiment, the boiling point range of the blend of the present invention is between about 210° C. to 390° C., more typically in the range of about 280° C. to 390° C., more typically in the range of 295° C. to 390° C. In one embodiment, boiling point of the blend of the present invention is in the range of about 215° C. to 400° C., typically in the range of about 220° C. to 350° C.

In one embodiment, the blend of dibasic esters has a boiling point range of between about 300° C. and 330° C. Typically, the diisoamyl AGS blend is associated with this boiling point range. In another embodiment, the dibasic ester blend of the present invention has a boiling point range of between about 295° C. and 310° C. Typically, the di-n-butyl AGS blend is associated with this boiling point range. Generally, a higher boiling point, typically, above 215° C., or high boiling point range corresponds to lower VOC.

The dibasic esters or blend of dibasic esters are incorporated into a cleaning composition of the present invention which, in one embodiment, comprises (a) a blend of dialkyl esters of adipic, glutaric, and succinic diacids or a blend of dialkyl esters of adipic, methylglutaric, and ethylsuccinic diacids; (b) at least one non-ionic surfactant; and, optionally, (c) water or a solvent. Additional components may be added including but not limited to a co-solvent and a co-surfactant. The co-surfactant can be any number of cationic, amphoteric, zwitterionic, anionic or nonionic surfactants, derivatives thereof, as well as blends of such surfactants. However, it is understood that the cleaning compositions of the present invention with additional components still remain infinitely dilutable and environmentally-friendly.

In one embodiment, the nonionic surfactants generally includes one or more of for example amides such as alkanolamides, ethoxylated alkanolamides, ethylene bisamides; esters such as fatty acid esters, glycerol esters, ethoxylated fatty acid esters, sorbitan esters, ethoxylated sorbitan; ethoxylates such as alkylphenol ethoxylates, alcohol ethoxylates, tristyrylphenol ethoxylates, mercaptan ethoxylates; end-capped and EO/PO block copolymers such as ethylene oxide/propylene oxide block copolymers, chlorine capped ethoxylates, tetra-functional block copolymers; amine oxides such lauramine oxide, cocamine oxide, stearamine oxide, stearamidopropylamine oxide, palmitamidopropylamine oxide, decylamine oxide; fatty alcohols such as decyl alcohol, lauryl alcohol, tridecyl alcohol, myristyl alcohol, cetyl alcohol, stearyl alcohol, oleyl alcohol, linoleyl alcohol and linolenyl alcohol; and alkoxylated alcohols such as ethoxylated lauryl alcohol, trideceth alcohols; and fatty acids such as lauric acid, oleic acid, stearic acid, myristic acid, cetearic acid, isostearic acid, linoleic acid, linolenic acid, ricinoleic acid, elaidic acid, arichidonic acid, myristoleic acid and mixtures thereof.

In one embodiment, the nonionic surfactant is a glycol such as polyethylene glycol (PEG), alkyl PEG esters, polypropylene glycol (PPG) and derivatives thereof. The nonionic surfactant can be one or more branched alcohol alkoxylates, one or more linear alcohol alkoxylates or a combination of one or more branched alcohol alkoxylates and one or more linear alcohol alkoxylates. In one embodiment, the nonionic surfactant is at least one branched C₅-C₂₀ alcohol butoxylate, at least one linear C₅-C₂₀ alcohol butoxylate, at least one branched C₅-C₂₀ alcohol propoxylate, at least one linear C₅-C₂₀ alcohol propoxylate, at least one branched C₅-C₂₀ alcohol ethoxylate, at least one linear C₅-C₂₀ alcohol ethoxylate and any combination thereof. In one exemplary embodiment, the nonionic surfactant is a C₆-C₁₃ alcohol ethoxylate and, more typically, a C₈-C₁₂ alcohol ethoxylate.

In one embodiment, cationic co-surfactants include but are not limited to quaternary ammonium compounds, such as cetyl trimethyl ammonium bromide (also known as CETAB or cetrimonium bromide), cetyl trimethyl ammonium chloride (also known as cetrimonium chloride), myristyl trimethyl ammonium bromide (also known as myrtrimonium bromide or Quaternium-13), stearyl dimethyl distearyldimonium chloride, dicetyl dimonium chloride, stearyl octyldimonium methosulfate, dihydrogenated palmoylethyl hydroxyethylmonium methosulfate, isostearyl benzylimidonium chloride, cocoyl benzyl hydroxyethyl imidazolinium chloride, dicetyl dimonium chloride and distearyldimonium chloride; isostearylaminopropalkonium chloride or olealkonium chloride; behentrimonium chloride; as well as mixtures thereof.

In another embodiment, anionic co-surfactants include but are not limited to linear alkylbenzene sulfonates, alpha olefin sulfonates, paraffin sulfonates, alkyl ester sulfonates, alkyl sulfates, alkyl alkoxy sulfates, alkyl sulfonates, alkyl alkoxy carboxylates, alkyl alkoxylated sulfates, monoalkyl phosphates, dialkyl phosphates, sarcosinates, sulfosuccinates, isethionates, and taurates, as well as mixtures thereof. Commonly used anionic surfactants that are suitable as the anionic surfactant component of the composition of the present invention include, for example, ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium-monoalkyl phosphates, sodium dialkyl phosphates, sodium lauroyl sarcosinate, lauroyl sarcosine, cocoyl sarcosine, ammonium cocyl sulfate, ammonium lauryl sulfate, sodium cocyl sulfate, sodium trideceth sulfate, sodium tridecyl sulfate, ammonium trideceth sulfate, ammonium tridecyl sulfate, sodium cocoyl isethionate, disodium laureth sulfosuccinate, sodium methyl oleoyl taurate, sodium laureth carboxylate, sodium trideceth carboxylate, sodium lauryl sulfate, potassium cocyl sulfate, potassium lauryl sulfate, monoethanolamine cocyl sulfate, sodium tridecyl benzene sulfonate, and sodium dodecyl benzene sulfonate. Branched anionic surfactants are particularly preferred, such as sodium trideceth sulfate, sodium tridecyl sulfate, ammonium trideceth sulfate, ammonium tridecyl sulfate, and sodium trideceth carboxylate.

Amphoteric co-surfactants acceptable for use include but are not limited to derivatives of aliphatic secondary and tertiary amines in which the aliphatic radical can be straight chain or branched and wherein one of the aliphatic substituents contains from about 8 to about 18 carbon atoms and one contains an anionic water solubilizing group. Specific examples of suitable amphoteric surfactants include the alkali metal, alkaline earth metal, ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates, such as for example, cocoamphoacetate cocoamphopropionate, cocoamphodiacetate, lauroamphoacetate, lauroamphodiacetate, lauroamphodipropionate, lauroamphodiacetate, cocoamphopropyl sulfonate caproamphodiacetate, caproamphoacetate, caproamphodipropionate, and stearoamphoacetate.

Suitable zwitterionic co-surfactants include but are not limited to alkyl betaines, such as cocodimethyl carboxymethyl betaine, lauryl dimethyl carboxymethyl betaine, lauryl dimethyl alpha-carboxy-ethyl betaine, cetyl dimethyl carboxymethyl betaine, lauryl bis-(2-hydroxy-ethyl)carboxy methyl betaine, stearyl bis-(2-hydroxy-propyl)carboxymethyl betaine, oleyl dimethyl gamma-carboxypropyl betaine, and lauryl bis-(2-hydroxypropyl)alpha-carboxyethyl betaine, amidopropyl betaines, and alkyl sultaines, such as cocodimethyl sulfopropyl betaine, stearyldimethyl sulfopropyl betaine, lauryl dimethyl sulfoethyl betaine, lauryl bis-(2-hydroxy-ethyl)sulfopropyl betaine, and alkylamidopropylhydroxy sultaines.

In one embodiment, the cleaning composition is an environmentally-friendly, biodegradable, low VOC cleaning composition comprising: (a) a blend of dibasic esters selected from dialkyl methylglutarate, dialkyl adipate, dialkyl ethylsuccinate, dialkyl succinate, dialkyl glutarate or any combination thereof; and (b) at least one nonionic surfactant, wherein the blend:surfactant ratio is less than or equal to about 2.3 (which in another embodiment is less than or equal to about 0.8); wherein the cleaning composition is in the form of a microemulsion when mixed in water and is dilutable with water by an amount of at least 99 parts water to 1 part said cleaning composition without phase separation. The “blend: surfactant ratio” or “solvent blend:surfactant ratio” is a ratio of the total solvent weight to total surfactant weight in the cleaning composition. For example, total weight of a co-solvent and dibasic ester blend would comprise the numerator portion of the solvent blend:surfactant ratio, if both solvents types are present in the composition. In some embodiments, “blend: surfactant ratio” or “solvent blend:surfactant ratio” means the weight of the blend of dibasic esters to the total weight of the surfactant in the cleaning composition, for example, where there is no co-solvent and only the dibasic ester blend present. The blend:surfactant ratio has a correlation to whether the cleaning composition is infinitely dilutable. The blend:surfactant ratio should stay constant regardless of the extent to which the cleaning composition is diluted, i.e., it should stay constant whether the cleaning composition is diluted by 10 parts water to 1 part composition, by weight, or diluted by 99 parts water to 1 part composition, by weight, or diluted by 200 parts water to 1 part composition, by weight. In one embodiment, the blend:surfactant ratio is less than or equal to 2.3 In one embodiment, the blend:surfactant ratio is less than or equal to 2. In one embodiment, the blend:surfactant ratio is less than or equal to 1.8. In one embodiment, the blend:surfactant ratio is less than or equal to 1.6. In one embodiment, the blend:surfactant ratio is less than or equal to 1.4. In one embodiment, the blend:surfactant ratio is less than or equal to 1.2. In one embodiment, the blend:surfactant ratio is less than or equal to 1. In one embodiment, the blend:surfactant ratio is less than or equal to 0.9. In another embodiment, the blend:surfactant ratio is less than or equal to 0.8. In one embodiment, the blend:surfactant ratio is less than or equal to 0.73, in another embodiment, the blend:surfactant ratio is less than or equal to 0.7. In another embodiment, the blend:surfactant ratio is less than or equal to 0.6. In yet another embodiment, the blend:surfactant ratio is less than or equal to 0.55. In yet another embodiment, the blend:surfactant ratio is less than or equal to 0.5. In yet another embodiment, the blend:surfactant ratio is less than or equal to 0.45. In a further embodiment, the blend:surfactant ratio is less than or equal to 0.4. In yet a further embodiment, the blend:surfactant ratio is less than or equal to 0.35. In another embodiment, the blend:surfactant ratio is less than or equal to 0.3. In another embodiment, the blend:surfactant ratio is less than or equal to 0.25. In an alternative embodiment, the blend:surfactant ratio is less than or equal to 0.2. In a further embodiment, the blend:surfactant ratio is less than or equal to 0.15.

The upper limit of the blend:surfactant ratio with respect to whether the cleaning composition is infinitely dilutable depends on the composition of the blend of dibasic esters described herein (e.g., MGN versus AGS) as well as the composition of the nonionic surfactant(s). Branched nonionic surfactants are more efficient (i.e., requires less amounts) in formulating an infinitely dilutable cleaning composition as compared to linear nonionic surfactants. Generally, the blend:surfactant ratio is less than or equal to 2.3, and in other embodiments, less than or equal to 2 where the cleaning composition comprises a blend of dibasic esters as described herein along with a co-solvent. Generally, the blend:surfactant ratio is less than or equal to 1, and in other embodiments, less than or equal to 0.8 where the cleaning composition comprises a blend of dibasic esters without a co-solvent.

The one or more co-solvents that can be included in said cleaning composition embodiment include, but are not limited to, saturated hydrocarbon solvents, glycol ethers, fatty acid methyl esters, aliphatic hydrocarbons solvents, acyclic hydrocarbons solvents, halogenated solvents, aromatic hydrocarbon solvents, cyclic terpenes, unsaturated hydrocarbon solvents, halocarbon solvents, polyols, ethers, glycol esters, alcohols, ketones, and any combination thereof. The addition of such a co-solvent can cause the solvent blend:surfactant ratio in the composition to increase.

The cleaning composition can further optionally comprise water, in some embodiments. In one particular embodiment, the cleaning composition comprises: (a) a blend of dibasic esters selected from dialkyl methylglutarate, dialkyl adipate, dialkyl ethylsuccinate, dialkyl succinate, dialkyl glutarate or any combination thereof; (b) at least one nonionic surfactant, wherein the blend:surfactant ratio is less than or equal to about 0.9; and (c) from about 1% to about 99%, by weight of the composition, of water; wherein the cleaning composition is in the form of a microemulsion and is dilutable with water by an amount of at least 99 parts water to 1 part said cleaning composition without phase separation. In one embodiment, the non-ionic surfactant can be one or more branched alcohol alkoxylates, one or more linear alcohol alkoxylates or a combination of one or more branched alcohol alkoxylates and one or more linear alcohol alkoxylates.

In one particular embodiment, the cleaning composition comprises: (a) a blend of dibasic esters comprising dialkyl methylglutarate and at least one of dialkyl adipate or dialkyl ethylsuccinate; (b) a C₅-C₁₄ branched alcohol ethoxylate surfactant; (c) a C₅-C₁₄ linear alcohol ethoxylate surfactant; and (d) from about 1% to about 3%, by weight of the composition, of water; wherein the blend:surfactant ratio is less than or equal to about 0.9 (surfactant being combined weight of surfactants); wherein the cleaning composition is in the form of a microemulsion and is dilutable with water by an amount of at least 99 parts water to 1 part said cleaning composition without phase separation. In another embodiment, where (b) a C₅-C₁₄ branched alcohol ethoxylate surfactant; (c) a C₅-C₁₄ linear or branched anionic surfactant; and (d) from about 1% to about 20%, by weight of the composition, of water.

In another particular embodiment, the cleaning composition comprises: (a) a blend of dibasic esters comprising dialkyl glutarate and at least one of dialkyl adipate or dialkyl succinate; (b) a C₅-C₁₄ branched alcohol ethoxylate surfactant; (c) a C₅-C₁₄ linear alcohol ethoxylate surfactant; and (d) from about 1% to about 3%, by weight of the composition, of water; wherein the blend:surfactant ratio is less than or equal to about 0.9 (surfactant being combined weight of surfactants); wherein the cleaning composition is in the form of a microemulsion and is dilutable with water by an amount of at least 99 parts water to 1 part said cleaning composition without phase separation. In another embodiment, where (b) a C₅-C₁₄ branched alcohol ethoxylate surfactant; (c) a C₅-C₁₄ linear or branched anionic surfactant; and (d) from about 1% to about 20%, by weight of the composition, of water. In another embodiment, the blend of dibasic esters comprises dialkyl glutarate, dialkyl adipate and dialkyl succinate.

In one embodiment, the cleaning composition is a microemulsion comprising (a) a blend of about 70-90% dialkyl dimethylglutarate, about 5-30% dialkyl ethylsuccinate and about 0-10% dialkyl adipate; (b) a nonionic surfactant composition comprising i) a branched alcohol alkoxylate or linear alcohol alkyxylate or both; and (d) water. Each alkyl substituent individually chosen from a hydrocarbon group containing from about 1 to 8 hydrocarbons such as methyl or ethyl, propyl, isopropyl, butyl, n-butyl or pentyl, or iso-amyl groups. Optionally, one or more additives or additional components such as delaminating agents, buffering and/or pH control agents, fragrances, opacifying agents, anti-corrosion agents, whiteners, defoamers, dyes, sudsing control agents, stabilizers, thickeners and the like can be added to the composition.

According to one embodiment of the present invention, the blend of dibasic esters corresponds to one or more by-products of the preparation of adipic acid, which is one of the main monomers in polyamides. For example, the dialkyl esters are obtained by esterification of one by-product, which generally contains, on a weight basis, from 15 to 33% succinic acid, from 50 to 75% glutaric acid and from 5 to 30% adipic acid. As another example, the dialkyl esters are obtained by esterification of a second by-product, which generally contains, on a weight basis, from 30 to 95% methyl glutaric acid, from 5 to 20% ethyl succinic acid and from 1 to 10% adipic acid. It is understood that the acid portion may be derived from such dibasic acids such as, adipic, succinic, glutaric, oxalic, malonic, pimelic, suberic and azelaic acids, as well as mixtures thereof.

In some embodiments, the dibasic ester blend comprises adducts of alcohol and linear diacids, the adducts having the formula R—OOC-A-COO—R wherein R is ethyl and A is a mixture of —(CH₂)₄—, —(CH₂)₃, and —(CH₂)₂—. In other embodiments, the blend comprises adducts of alcohol, typically ethanol, and linear diacids, the adducts having the formula R¹—OOC-A-COO—R², wherein at least part of R¹ and/or R² are residues of at least one linear alcohol having 4 carbon atoms, and/or at least one linear or branched alcohol having at least 5 carbon atoms, and wherein A is a divalent linear hydrocarbon. In some embodiments A is one or a mixture of —(CH₂)₄—, —(CH₂)₃, and —(CH₂)₂—.

In another embodiment, the R¹ and/or R² groups can be linear or branched, cyclic or noncyclic, C₁-C₂₀ alkyl, aryl, alkylaryl or arylalkyl groups. Typically, the R¹ and/or R² groups can be C₁-C₈ groups, for example groups chosen from the methyl, ethyl, n-propyl, isopropyl, n-butyl, n-amyl, n-hexyl, cyclohexyl, 2-ethylhexyl and isooctyl groups and their mixtures. For example, R¹ and/or R² can both or individually be ethyl groups, R¹ and/or R² can both or individually be n-propyl groups, R¹ and/or R² can both or individually be isopropyl groups, R¹ and/or R² can both or individually be n-butyl groups, R¹ and/or R² can both or individually be iso-amyl groups, R¹ and/or R² can both or individually be n-amyl groups, or R¹ and/or R² can be mixtures thereof (e.g., when comprising a blend of dibasic esters).

In further embodiments the invention can include blends comprising adducts of branched diacids, the adducts having the formula R³—OOC-A-COO—R⁴ wherein R³ and R⁴ are the same or different alkyl groups and A is a branched or linear hydrocarbon. Typically, A comprises an isomer of a C₄ hydrocarbon. Examples include those where R³ and/or R⁴ can be linear or branched, cyclic or noncyclic, C₁-C₂₀ alkyl, aryl, alkylaryl or arylalkyl groups. Typically, R³ and R⁴ are independently selected from the group consisting of methyl, ethyl, propyl, isopropyl, butyl, n-butyl, iso-butyl, iso-amyl, and fusel.

In yet another embodiment, the invention comprises a composition based on dicarboxylic acid diester(s) of formula R⁵—OOC-A-COO—R⁶ wherein group A represents a divalent alkylene group typically in the range of, on average, from 2.5 to 10 carbon atoms. R⁵ and R⁶ groups, which can be identical or different, represent a linear or branched, cyclic or noncyclic, C₁-C₂₀ alkyl, aryl, alkylaryl or an arylalkyl group.

The blend can correspond to a complex reaction product, where mixtures of reactants are used. For example, the reaction of a mixture of HOOC-A^{a}-COOH and HOOC-A^{b}-COOH with an alcohol R^{a}—OH can give a mixture of the products R^{a}OOC-A^{a}-COOR^{a} and R^{a}OOC-A^{b}-COOR^{a}. Likewise, the reaction of HOOC-A^{a}-COOH with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b} and R^{b}OOC-A^{a}-COOR^{a} (different from R^{a}OOC-A^{a}-COOR^{b} if A^{a} is not symmetrical). Likewise, the reaction of a mixture of HOOC-A^{a}-COOH and HOOC-A^{b}-COOH with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b}, R^{b}OOC-A^{a}-COOR^{a} (different from R^{a}OOC-A^{a}-COOR^{b} if A^{a} is not symmetrical), R^{a}OOC-A^{b}-COOR^{a} and R^{b}OOC-A^{b}-COOR^{b}, R^{a}OOC-A^{b}-COOR^{b} and R^{b}OOC-A^{b}-COOR^{a} (different from R^{a}OOC-A^{b}-COOR^{b} if A^{b} is not symmetrical).

The groups R¹ and R², can correspond to alcohols R¹—OH and R²—OH (respectively). These groups can be likened to the alcohols. The group(s) A, can correspond to one or more dicarboxylic acid(s) HOOC-A-COOH. The group(s) A can be likened to the corresponding diacid(s) (the diacid comprises 2 more carbon atoms than the group A).

In one embodiment, group A is a divalent alkylene group comprising, on average, more than 2 carbon atoms. It can be a single group, with an integral number of carbon atoms of greater than or equal to 3, for example equal to 3 or 4. Such a single group can correspond to the use of a single acid. Typically, however, it corresponds to a mixture of groups corresponding to a mixture of compounds, at least one of which exhibits at least 3 carbon atoms. It is understood that the mixtures of groups A can correspond to mixtures of different isomeric groups comprising an identical number of carbon atoms and/or of different groups comprising different numbers of carbon atoms. The group A can comprise linear and/or branched groups.

According to one embodiment, at least a portion of the groups A corresponds to a group of formula —(CH₂)ₙ— where n is a mean number greater than or equal to 3. At least a portion of the groups A can be groups of formula —(CH₂)₄— (the corresponding acid is adipic acid). For example, A can be a group of formula —(CH₂)₄—, and/or a group of formula —(CH₂)₃—.

In one embodiment, the composition comprises compounds of formula R—OOC-A-COO—R where A is a group of formula —(CH₂)₄—, compounds of formula R—OOC-A-COO—R where A is a group of formula —(CH₂)₃—, and compounds of formula R—OOC-A-COO—R where A is a group of formula —(CH₂)₂—.

The blend of dibasic esters is typically present in the cleaning composition in microemulsion form (liquid droplets dispersed in the aqueous phase). Without wishing to be bound to any theory, it is pointed out that microemulsions are generally thermodynamically stable systems generally comprising emulsifiers, meaning it is at its lowest energy state. Microemulsions can be prepared by gently mixing or gently shaking the components together. The other emulsions (macroemulsions) are generally systems in thermodynamically unstable state (are only kinetically stable), conserving for a certain time, in metastable state, the mechanical energy supplied during the emulsification. These systems generally comprise smaller amounts of emulsifiers.

In one embodiment, the microemulsion of the present invention is an emulsion whose mean droplet size is generally less than or equal to about 0.15 μm. The size of the microemulsion droplets may be measured by dynamic light scattering (DLS), for example as described below. The apparatus used consists, for example, of a Spectra-Physics 2020 laser, a Brookhaven 2030 correlator and the associated computer-based equipment. If the sample is concentrated, it may be diluted in deionized water and filtered through a 0.22 van filter to have a final concentration of 2% by weight. The diameter obtained is an apparent diameter. The measurements are taken at angles of 90° and 135°. For the size measurements, besides the standard analysis with cumulents, three exploitations of the autocorrelation function are used (exponential sampling or EXPSAM described by Prof. Pike, the “Non Negatively Constrained Least Squares” or NNLS method, and the CONTIN method described by Prof Provencher), which each give a size distribution weighted by the scattered intensity, rather than by the mass or the number. The refractive index and the viscosity of the water are taken into account.

According to one embodiment, the microemulsion is transparent. The microemulsion may have, for example, a transmittance of at least 90% and preferably of at least 95% at a wavelength of 600 nm, for example measured using a Lambda 40 UV-visible spectrometer.

According to another embodiment, the emulsion is an emulsion whose mean droplet size is greater than or equal to 0.15 μm, for example greater than 0.5 μm, or 1 μm, or 2 μm, or μm, or 20 μm, and preferably less than 100 μm. The droplet size may be measured by optical microscopy and/or laser granulometry (Horiba LA-910 laser scattering analyzer).

In certain embodiments, the dibasic ester blend comprises:

a diester of formula I:

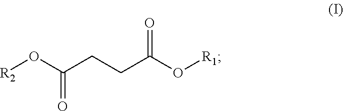

a diester of formula II:

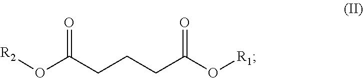

and

a diester of formula III:

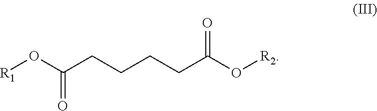

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl or octyl. In such embodiments, the blend typically comprises (by weight of the blend) (i) about 15% to about 35% of the diester of formula I, (ii) about 55% to about 70% of the diester of formula II, and (iii) about 7% to about 20% of the diester of formula III, and more typically, (i) about 20% to about 28% of the diester of formula I, (ii) about 59% to about 67% of the diester of formula II, and (iii) about 9% to about 17% of the diester of formula III. The blend is generally characterized by a flash point of 98° C., a vapor pressure at 20° C. of less than about 10 Pa, and a distillation temperature range of about 200-300° C. Mention may also be made of Rhodiasolv® RPDE (Rhodia Inc., Cranbury, N.J.), Rhodiasolv® DIB (Rhodia Inc., Cranbury, N.J.) and Rhodiasolv® DEE (Rhodia Inc., Cranbury, N.J.).

In certain other embodiments, the dibasic ester blend comprises:

a diester of the formula IV:

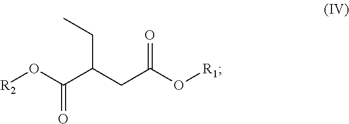

a diester of the formula V:

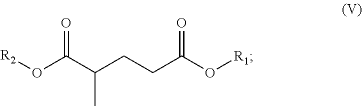

and

a diester of the formula VI:

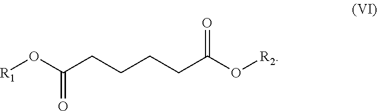

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl, or octyl. In such embodiments, the blend typically comprises (by weight of the blend) (i) from about 5% to about 30% of the diester of formula IV, (ii) from about 70% to about 95% of the diester of formula V, and (iii) from about 0% to about 10% of the diester of formula VI. More typically, the blend typically comprises (by weight of the blend): (i) from about 6% to about 12% of the diester of formula IV, (ii) from about 86% to about 92% of the diester of formula V, and (iii) from about 0.5% to about 4% of the diester of formula VI.

Most typically, the blend comprises (by weight of the blend): (i) about 9% of the diester of formula IV, (ii) about 89% of the diester of formula V, and (iii) about 1% of the diester of formula VI. The blend is generally characterized by a flash point of 98° C., a vapor pressure at 20° C. of less than about 10 Pa, and a distillation temperature range of about 200-275° C. Mention may be made of Rhodiasolv® IRIS and Rhodiasolv® DEE/M, manufactured by Rhodia Inc. (manufactured by Rhodia Inc., Cranbury, N.J.)

In one embodiment, water can include but is not limited to tap water, filtered water, bottled water, spring water, distilled water, deionized water, and/or industrial soft water.

In another embodiment, the solvent can include organic solvents, including but not limited to aliphatic or acyclic hydrocarbons solvents, halogenated solvents, aromatic hydrocarbon solvents, glycol ether, a cyclic terpene, unsaturated hydrocarbon solvents, halocarbon solvents, polyols, ethers, esters of a glycol ether, alcohols including short chain alcohols, ketones or mixtures thereof.

In one embodiment, additional surfactants may be utilized in the present invention. Surfactants that are useful for preparing the microemulsion of the present invention can be one or more anionic surfactants, cationic surfactants, non-ionic surfactants, zwitterionic surfactants, amphoteric surfactants.

Typically nonionic surfactants are utilized, which include but are not limited to polyalkoxylated surfactants, for example chosen from alkoxylated alcohols, alkoxylated fatty alcohols, alkoxylated triglycerides, alkoxylated fatty acids, alkoxylated sorbitan esters, alkoxylated fatty amines, alkoxylated bis(1-phenylethyl)phenols, alkoxylated tris(1-phenylethyl)phenols and alkoxylated alkylphenols, in which the number of alkoxy and more particularly oxyethylene and/or oxypropylene units is such that the HLB value is greater than or equal to 10. More typically, the nonionic surfactant can be selected from the group consisting of ethylene oxide/propylene oxide copolymers, terpene alkoxylates, alcohol ethoxylates, alkyl phenol ethoxylates and combinations thereof.

In one embodiment, the alcohol ethoxylates used in connection with the present invention have the formula:

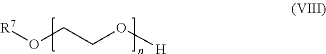

Typically, R⁷ is a hydrogen or a hydrocarbon chain containing about 5 to about 25 carbon atoms, more typically from about 7 to about 14 carbon atoms, most typically, from about 8 to about 13 carbon atoms, and may be branched or straight-chained and saturated or unsaturated and is selected from the group consisting of hydrogen, alkyl, alkoxy, aryl, alkaryl, alkylarylalkyl and arylalkyl. Typically, “n” is an integer from about 1 to about 30, more typically an integer from 2 to about 20, and most typically an integer from about 3 to about 12. In another embodiment, “n” is an integer from about 3 to about 10.

In another embodiment, the non-ionic surfactant has formula:

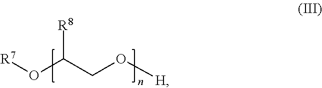

wherein R⁷ is a hydrogen or a branched hydrocarbon chain containing from about 5 to about 25 carbon atoms, R⁸ is a hydrogen or a hydrocarbon chain containing from about 1 to about 5 carbon atoms; “n” is an integer from about 1 to about 30, more typically an integer from 2 to about 20, and most typically an integer from about 3 to about 12. In another embodiment, “n” is an integer from about 3 to about 10.

In an alternative embodiment, the alcohol ethoxylate is sold under the trade name Rhodasurf 91-6 (manufactured by Rhodia Inc., Cranbury, N.J.).

In yet another embodiment, nonionic surfactants used include but not limited to: polyoxyalkylenated C6-C24 aliphatic alcohols comprising from 2 to 50 oxyalkylene (oxyethylene and/or oxypropylene) units, in particular of those with 12 (mean) carbon atoms or with 18 (mean) carbon atoms; mention may be made of Antarox B12DF, Antarox FM33, Antarox FM63 and Antarox V74, Rhodasurf ID 060, Rhodasurf ID 070 and Rhodasurf LA 42 from (Rhodia Inc., Cranbury, N.J.), as well as polyoxyalkylenated C8-C22 aliphatic alcohols containing from 1 to 25 oxyalkylene (oxyethylene or oxypropylene) units.

In a further embodiment, the surfactant comprises a terpene or a terpene alkoxylate. Terpene alkoxylates are terpene-based surfactants derived from a renewable raw materials such as α-pinene and β-pinene, and have a C-9 bicyclic alkyl hydrophobe and polyoxy alkylene units in an block distribution or intermixed in random or tapered distribution along the hydrophilic chain. The terpene alkoxylate surfactants are described in the U.S. Patent Application Publication No. 2006/0135683 to Adam al., Jun. 22, 2006, is incorporated herein by reference.

In a further or alternative embodiment, additional components or additives may be added to the cleaning composition of the present invention. The additional components include, but are not limited to, delaminates, buffering and/or pH control agents, fragrances, perfumes, defoamers, dyes, whiteners, brighteners, solubilizing materials, stabilizers, thickeners, corrosion inhibitors, lotions and/or mineral oils, enzymes, cloud point modifiers, preservatives, ion exchangers, chelating agents, sudsing control agents, soil removal agents, softening agents, opacifiers, inert diluents, graying inhibitors, stabilizers, polymers and the like.

Typically, additional components comprise one or more delaminates. Delaminates can be certain terpene-based derivatives that can include, but are not limited to, pinene and pinene derivatives, d-limonene, dipentene and oc-pinene.

The buffering and pH control agents include for example, organic acids, mineral acids, as well as alkali metal and alkaline earth salts of silicate, metasilicate, polysilicate, borate, carbonate, carbamate, phosphate, polyphosphate, pyrophosphates, triphosphates, ammonia, hydroxide, monoethanolamine, monopropanolamine, diethanolamine, dipropanolamine, triethanolamine, and/or 2-amino-2-methylpropanol.

More specifically, the buffering agent can be a detergent or a low molecular weight, organic or inorganic material used for maintaining the desired pH. The buffer can be alkaline, acidic or neutral, including but not limited to 2-amino-2-methyl-propanol; 2-amino-2-methyl-1,3-propanol; disodium glutamate; methyl diethanolamide; N,N-bis(2-hydroxyethyl)glycine; tris(hydroxymethyl)methyl glycine; ammonium carbamate; citric acid; acetic acid; ammonia; alkali metal carbonates; and/or alkali metal phosphates.

In still another embodiment, thickeners, when used, include, but are not limited to, cassia gum, tara gum, xanthan gum, locust beam gum, carrageenan gum, gum karaya, gum arabic, hyaluronic acids, succinoglycan, pectin, crystalline polysaccharides, branched polysaccharide, calcium carbonate, aluminum oxide, alginates, guar gum, hydroxypropyl guar gum, carboxymethyl guar gum, carboxymethylhydroxypropyl guar gum, and other modified guar gums, hydroxycelluloses, hydroxyalkyl cellulose, including hydroxyethyl cellulose, carboxymethylhydroxyethyl cellulose, hydroxypropyl cellulose, carboxymethylcellulose and/or other modified celluloses. In a further embodiment, the whiteners include, but are not limited to, percarbonates, peracids, perborates, chlorine-generating substances hydrogen peroxide, and/or hydrogen peroxide-based compounds. In another embodiment, the polymer is generally a water soluble or dispersable polymer having a weight average molecular weight of generally below 2,000,000.

Since dibasic esters are subject to hydrolysis under certain conditions, it is understood that the blend of dibasic esters can contain a minute amount of alcohol, typically a low molecular weight alcohol such as ethanol, in concentrations of about 2% to about 0.2%.

A generally contemplated cleaning composition, in one embodiment, comprises (based on the total weight of the composition) (a) from about 1% to about 44.5% by weight a blend of dibasic esters and (b) greater than about 55.5% by weight one or more nonionic surfactants. In another embodiment, the cleaning composition comprises (based on the total weight of the composition) (a) from about 1% to about 40% by weight a blend of dibasic esters and (b) greater than about 50% by weight one or more nonionic surfactants. In another embodiment, the cleaning composition comprises (based on the total weight of the composition) (a) from about 1% to about 35% by weight a blend of dibasic esters and (b) greater than about 40% by weight one or more nonionic surfactants. In a particular embodiment, the blend:surfactant ratio (by weight) is less than 2.3 or 2 or 1.8 or 1.6 or 1.2 or 1 or 0.8 or 0.75 or 0.7 or 0.65 or 0.6 or 0.55 or 0.5 or 0.45 or 0.4 or 0.35 or 0.3. In one embodiment, the composition may optionally contain water or a solvent in varying amounts, depending on the desired concentration. For example, it may be desirable to have the composition of the present invention as a concentrated composition for shipping, transportation purposes as well as for other cost savings. It may also be desirable to have the present invention in fully diluted form.

In either concentrated or diluted form, the composition of the present invention is hydrolytically stable, typically up to 6 months or greater, more typically up to 12 months or greater for the diluted form and longer in the concentrated form. The formulations of the present invention, which contain the dibasic ester blends, typically, MGN blends, have hydrolysis stability, where hydrolysis/decomposition typically produces the acid form of the ester and methanol. The methanol concentration of the formulation comprising the described dibasic ester blend was monitored and shown to generally be stable, typically less than 1000 ppm (parts per million), more typically less than or about 600 ppm, typically at or less than about 300 ppm. (When prior art ester-based cleaning solutions sit in an aqueous solution, the esters typically begin to decompose. The decomposing ester produces undesirable and potentially hazardous byproducts. Furthermore, as the ester decomposes, the amount of ester, which is the active ingredient in the cleaning solution, is decreasing.)

The present invention in one embodiment, is a method for removing stains (including but limited to pencil, crayon, highlighter, ketchup, permanent marker, mustard, ink, washable marker, lipstick, and hydrophobic stains in general), ink (typically, printing ink), organic stains on clothes, resin, tar-resin, graffiti, stains on painted surfaces or plastic or metal substrates, from skin or hair, paint from a surface, or as a degreasing composition, comprising obtaining the cleaning composition of the present invention, contacting any embodiments of the cleaning composition described herein with a surface having any of the above-referenced stain on it, and removing the used cleaning composition from the cleaned surface.

In a further aspect, described herein are methods of cleaning surfaces comprising: (a) providing any of the concentrated cleaning compositions described (generally containing less than about 10% water, more typically less than 5% water, even more typically less than 2% water) herein that are diluted with in an amount from about 1% to about 99%, by weight of the composition, of water; (b) contacting the cleaning composition with a surface having one or more contaminants on it; and (c) removing the used cleaning composition from the surface.

### EXPERIMENTS

### Example 1

### Phase Behavior IRIS-Alcohol Ethoxylate (C10-EO6)

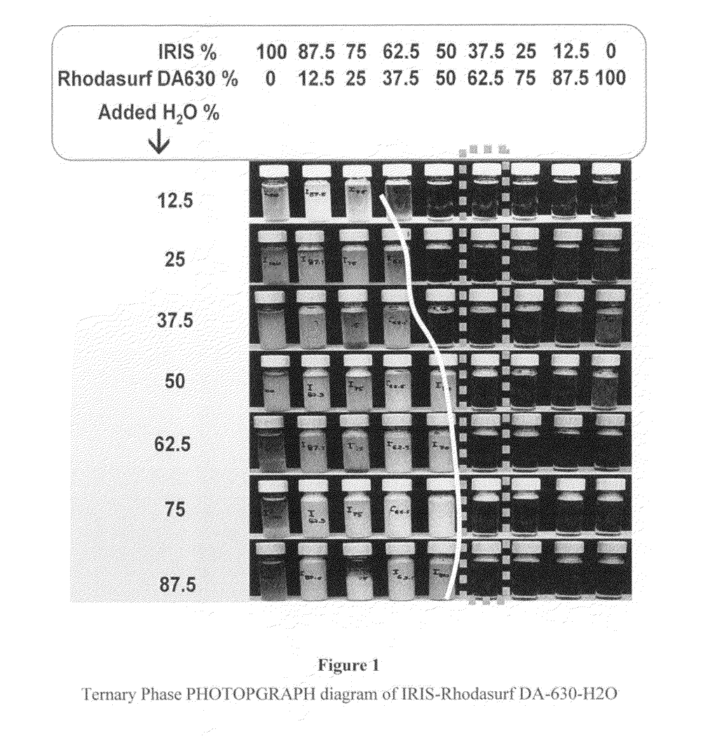

Referring to FIG. 1, this example details the formulation of infinitely or extremely dilutable microemulsion concentrate with Rhodiasolv IRIS (containing dimethyl methylglutarate) and an alcohol ethoxylate (with approximately 7-13 carbon atoms and 5-12 moles of EO). As described above, Rhodiasolv IRIS is a blend of branched diesters from the methylglutaronitrile product stream in the manufacture of adiponitrile. This example compares Rhodasurf 91-6 which is a linear alcohol ethoxylate (AE) vs. Rhodasurf DA-630 which is a branched isodecyl alcohol ethoxylate homologue with the same EO. The HLB for both surfactants is approximately 12 and they are readily biodegradable. FIG. 1 shows blend compositions of IRIS (100%-0%) and Rhodasurf DA-630 (0%-100%) and 0% H₂O as the top row. Progressively increasing amount of water is added in subsequent rows such that the solvent surfactant ratio is constant in any given column. FIG. 1 identifies that an IRIS:Rhodasurf DA-630 blend in the ratio 37.5:62.5 is infinitely dilutable and gives clear stable emulsions for all dilutions (up to 87.5% shown here) shown by dotted boundary. Greater than 87.5% dilutions are also clear.

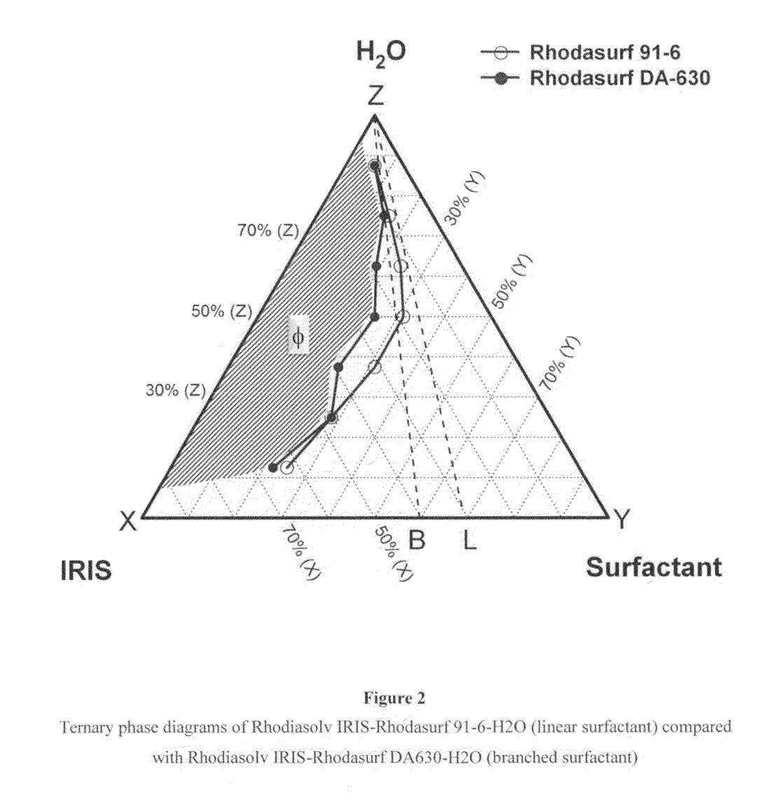

Referring to FIG. 2, the figure shows a ternary phase diagram of blends of IRIS with Rhodasurf 91-6 (a linear alcohol ethoxylate) superposed with blends of IRIS with Rhodasurf DA-630. Phase boundaries are drawn with the zone “φ” to the left of the boundaries and bound by the ZX axis being the phase separated zone. In FIG. 2, if one draws dilution lines (dashed) skirting the phase boundaries, the intersection of the line with XY axis defines the IRIS:Surfactant composition which will be infinitely dilutable. For Rhodasurf DA-630 blend with IRIS:surfactant ratio of 40:60 is found to be infinitely or extremely dilutable (line ZB) giving clear stable emulsions at all dilutions. For Rhodasurf 91-6 blend with IRIS:surfactant ratio of 30:70 is found to be infinitely or extremely dilutable (line ZL) giving clear stable emulsions at all dilutions. If the solvent:surfactant ratio is increased (e.g. to 50:50) then dilution of the blend would result in an unstable phase separated solution as the water content is increased (e.g. >=40%). This clearly outlines that the use of the branched homologue DA-630 is substantially more efficient in formulating infinitely dilutable emulsions of IRIS than its linear counterpart.

### Example 2

### Phase Behavior RPDE-Alcohol Ethoxylate (C10-EO6) (Different Methyl Ester Solvent)

This example details the formulation of infinitely dilutable microemulsion concentrate with Rhodiasolv RPDE (blend of dimethyl adipate, dimethyl glutarate and dimethyl succinate) and alcohol ethoxylate with approximately 7-13 carbon atoms and 5-12 moles of EO. This example compares Rhodasurf 91-6, a linear AE vs. Rhodasurf DA-630 which is a branched isodecyl alcohol ethoxylate homologue with the similar EO group. The HLB for both surfactants is approximately 12. The example deals with a different dibasic ester with different solubility parameters compared to Rhodiasolv IRIS.

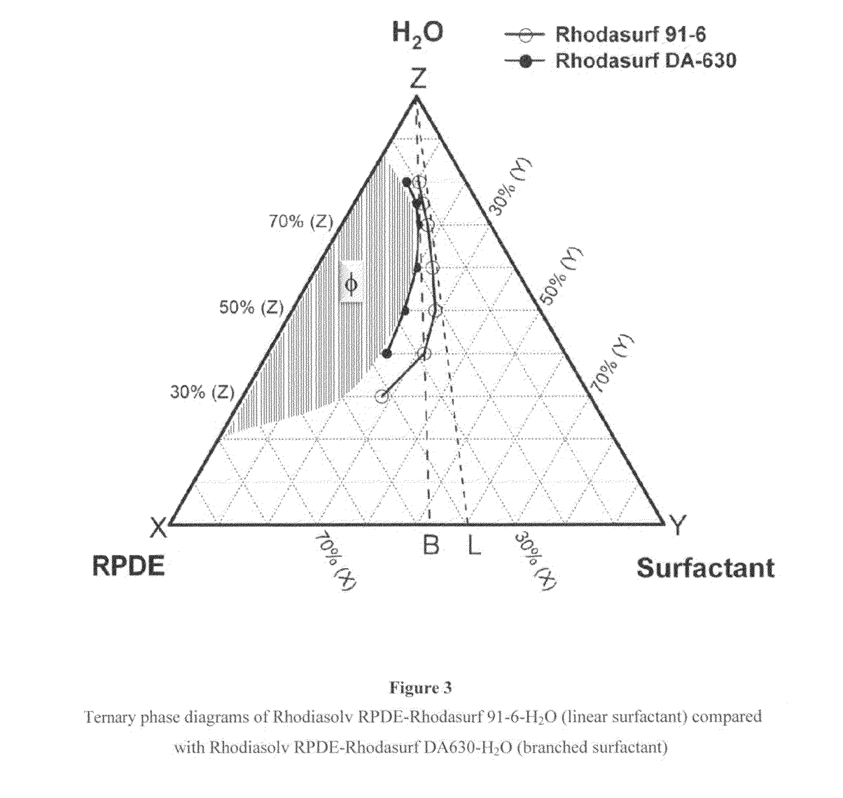

FIG. 3 shows blend compositions of RPDE (60%-20%) and Rhodasurf 91-6 (40%-80%) and H₂O superposed with blends of RPDE with Rhodasurf DA-630. FIG. 3 identifies that an RPDE:Rhodasurf 91-6 blend in the ratio 40:60 is infinitely dilutable (line ZL) and gives clear stable emulsions for all dilutions (up to 80% shown here) shown by dotted boundary. Greater than 80% dilutions are also clear. If the solvent:surfactant ratio (or, otherwise, blend:surfactant ratio) is increased (e.g. to 42.5:57.5) then dilution of the blend would result in an unstable phase separated solution as the water content is increased (e.g. >=45%).

FIG. 3 also shows a similar phase boundary of blends of RPDE with Rhodasurf DA-630. Here blend with RPDE:surfactant ratio of 47.5:52.5 is found to be infinitely dilutable (line ZB) giving clear stable emulsions at all dilutions. This clearly outlines that the use of the branched homologue DA-630 is substantially more efficient in formulating infinitely dilutable emulsions of RPDE than its linear counterpart. The overall solvent:surfactant ratio is greater for RPDE compared to IRIS since RPDE is more water soluble compared to IRIS. The example here illustrates that the branched alcohol ethoxylate surfactants are consistently more efficient for both a linear backbone diester (RPDE) and a branched diester (IRIS) as shown in Example 1.

### Example 3

### Phase Behavior RPDE-Alcohol Ethoxylate (C13-EO7-8) (Different Surfactant Pair)

This example details the formulation of infinitely dilutable microemulsion concentrate with Rhodiasolv RPDE (blend of dimethyl adipate, dimethyl glutarate and dimethyl succinate) and alcohol ethoxylate with approximately 8-13 carbon atoms and 6-10 moles of EO. This example compares Rhodasurf LA-7, a linear alcohol ethoxylate vs. Rhodasurf TDA 8/5 which is a branched tridecyl alcohol ethoxylate homologue with the similar EO group. The HLB for both surfactants is approximately 12. The example deals with a different alcohol ethoxylate pair.

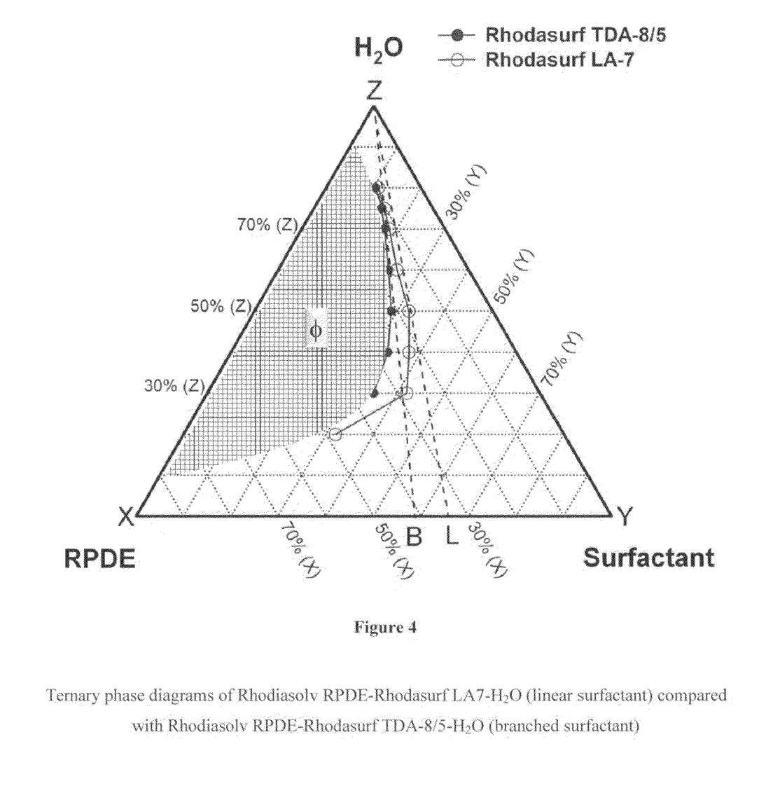

FIG. 4, shows blend compositions of RPDE (60%-20%) and Rhodasurf LA-7 (40%-80%) and H₂O. FIG. 4 identifies that an RPDE:Rhodasurf LA-7 blend in the ratio 35:65 is infinitely dilutable (line ZL) and gives clear stable emulsions for all dilutions (upto 80% shown here) shown by the boundary. Greater than 80% dilutions are also clear. If the solvent:surfactant ratio is increased (e.g. to 40:60) then dilution of the blend would result in an unstable phase separated solution as the water content is increased (e.g. >=30%). It is also evident here that for the same solvent system a larger hydrophobe with a proportionately greater EO content in the surfactant results in a lower solvent:surfactant ratio in the formulation of an infinitely dilutable concentrate.

FIG. 4 also shows a similar phase diagram of blends of RPDE with Rhodasurf TDA 8/5 with water. The blend with RPDE:surfactant ratio of 40:60 is found to be infinitely dilutable giving stable emulsions at all dilutions. There in a slightly hazy solution structure forming in the dilution levels <30% H₂O. Those slightly hazy (water in oil emulsions) are found to be stable emulsions. This similarly outlines that the use of the branched homologue TDA-8/5 is more efficient in formulating dilutable emulsions of RPDE than its linear counterpart. The example here illustrates that the branched alcohol ethoxylate surfactants are consistently more efficient than their linear counterpart in making infinitely dilutable microemulsions of diesters regardless of the hydrophobe EO moles having a similar HLB.

### Example 3

### Phase Behavior DEE-Alcohol Ethoxylate (C10-EO6) (Diethyl Ester)

This example details the formulation of infinitely dilutable microemulsion concentrate with Rhodiasolv DEE (blend of diethyl adipate, diethyl glutarate and diethyl succinate) and alcohol ethoxylate with approximately 10-12 carbon atoms and 5-12 moles of EO. This example compares Rhodarusrf 91-6, a linear (C₉₋₁₁ EO₅₋₉) AE vs. Rhodasurf DA-630 which is branched isodecyl alcohol ethoxylate homologue with the similar EO group. The HLB for both surfactants is approximately 12. The example deals with a different diethyl ester compared to previous examples with dimethyl ester solvents.

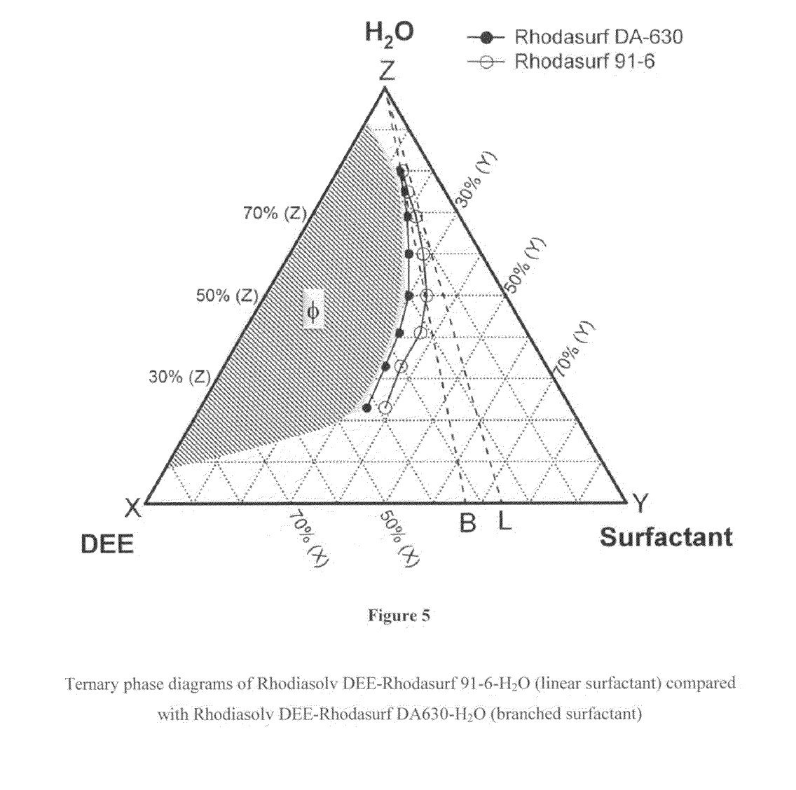

FIG. 5 shows blend compositions of DEE (50%-20%) and Rhodasurf 91-6 (50%-80%) and H₂O. FIG. 5 identifies that an DEE:Rhodasurf 91-6 blend in the ratio 25:75 is infinitely dilutable (line ZL) and gives clear stable emulsions for all dilutions (up to 80% shown here) shown by boundary. Greater than 80% dilutions are also clear. If the solvent:surfactant ratio is increased (e.g. to 32.5:67.5) then dilution of the blend would result in an unstable phase separated solution as the water content is increased (e.g. >=50%).

FIG. 5, also shows a similar phase diagram of blends of DEE with Rhodasurf DA-630 with progressively increasing amount of water added in subsequent rows such that the solvent surfactant ratio is constant in any given column. Here blend with DEE:surfactant ratio of 32.5:67.5 is found to be infinitely dilutable (line ZB) giving stable emulsions at all dilutions. This similarly outlines that the use of the branched homologue DA-630 is more efficient in formulating dilutable emulsions of DEE than its linear counterpart 91-6. The example here illustrates that the branched alcohol ethoxylate surfactants are consistently more efficient in making infinitely dilutable microemulsions of diesters for diethyl esters as with the dimethyl esters considered above.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. Consequently, the invention is intended to be limited only by the spirit and scope of the appended claims, giving full cognizance to equivalents in all respects.

1. An environmentally-friendly, readily biodegradable, low VOC cleaning composition comprising:
(a) a blend of dibasic esters selected from the group consisting of dialkyl methylglutarate, dialkyl adipate, dialkyl ethylsuccinate, dialkyl succinate, dialkyl glutarate and any combination thereof; and
(b) at least one nonionic surfactant, wherein the blend:surfactant ratio (by weight) is less than or equal to 0.9:1;
wherein the cleaning composition is in the form of a microemulsion when mixed in water and is dilutable with water by an amount of at least 99 parts water to 1 part said cleaning composition without phase separation.

2. The cleaning composition of claim 1 wherein the blend:surfactant ratio (by weight) is less than or equal to 0.6:1.

3. The cleaning composition of claim 1 wherein the blend of dibasic esters comprises (i) a dialkyl methylglutarate, (ii) a dialkyl ethylsuccinate and, optionally, (iii) a dialkyl adipate.

4. The cleaning composition of claim 1 wherein the at least one nonionic surfactant is a branched C₅-C₁₅ alcohol ethoxylate.

5. The cleaning composition of claim 1 wherein the nonionic surfactant is selected from the group consisting of at least one branched alcohol alkoxylate, at least one linear alcohol alkoxylate and any combination thereof.

6. The cleaning composition of claim 1 wherein the non-ionic surfactant is selected from the group consisting of at least one branched C₅-C₂₀ alcohol butoxylate, at least one linear C₅-C₂₀ alcohol butoxylate, at least one branched C₅-C₂₀ alcohol propoxylate, at least one linear C₅-C₂₀ alcohol propoxylate, at least one branched C₅-C₂₀ alcohol ethoxylate, at least one linear C₅-C₂₀ alcohol ethoxylate and any combination thereof.

7. The cleaning composition of claim 1 further comprising water.

8. The cleaning composition of claim 1 wherein the blend of dibasic esters is derived from one or more by-products in the production of polyamide.

9. The cleaning composition of claim 3 wherein the blend of dibasic esters is derived from the process to produce adiponitrile.

10. The cleaning composition of claim 3 wherein the blend of dibasic esters is present in an amount from about 1% to about 40% by weight of the composition, and the at least one nonionic surfactant is present in an amount greater than about 50% by weight of the composition.

11. The cleaning composition of claim 1 wherein the blend of dibasic esters comprises:
(i) from about 5-25%, by weight of the blend, a first dibasic ester of formula: 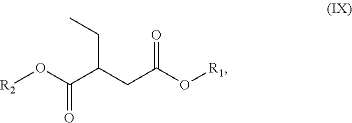
(ii) from about 70-95%, by weight of the blend, a second dibasic ester of formula: 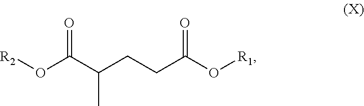
and
(iii) from about 0-5%, by weight of the blend, a third dibasic ester of formula: 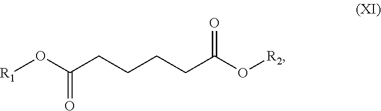
wherein R₁ and R₂ are individually selected from branched, linear or cyclic C₁-C₁₀ hydrocarbon groups.

12. The cleaning composition of claim 11 wherein the blend of dibasic esters is characterized by vapor pressure of less than about 10 Pa.

13. The cleaning composition of claim 1 wherein the blend of dibasic esters comprises:
(i) from about 20-28%, by weight of the blend, a first dibasic ester of formula: 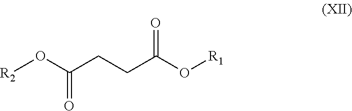
(ii) from about 59-67%, by weight of the blend, a second dibasic ester of formula: 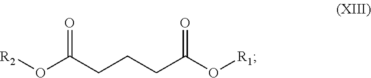
and
(iii) from about 9-17%, by weight of the blend, a third dibasic ester of formula: 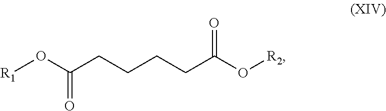
wherein R₁ and R₂ are individually selected from branched, linear or cyclic C₁-C₁₀ hydrocarbon groups.

14. The cleaning composition of claim 1 wherein the non-ionic surfactant is of formula: 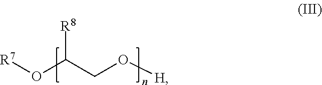
wherein R⁷ is a hydrogen or a branched hydrocarbon chain containing from about 5 to about 25 carbon atoms, R⁸ is a hydrogen or a hydrocarbon chain containing from about 1 to about 5 carbon atoms; “n” is an integer from about 1 to about 30.

15. The cleaning composition of claim 1 further comprising (c) from about 1% to about 99%, by weight of the composition, of water.

16. The cleaning composition of claim 1 further comprising at least one co-surfactant.

17. An infinitely dilutable, environmentally-friendly, biodegradable, low VOC cleaning composition comprising:
(a) from about 1% to about 40%, by weight of the composition, a blend of dibasic esters comprising:
(i) from about 5-25%, by weight of the blend, a first dibasic ester of formula: 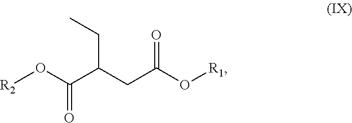
(ii) from about 70-95%, by weight of the blend, a second dibasic ester of formula: 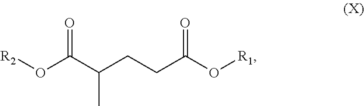
and
(iii) from about 0-5%, by weight of the blend, a third dibasic ester of formula: 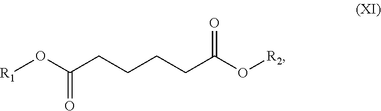
wherein R₁ and R₂ are individually selected from branched, linear or cyclic C₁-C₁₀ hydrocarbon groups;
(b) greater than about 50%, by weight of the composition, of at least one nonionic, surfactant of formula: 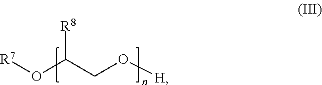
wherein R⁷ is a hydrogen or a branched hydrocarbon chain containing from about 5 to about 25 carbon atoms, R⁸ is a hydrogen or a hydrocarbon chain containing from about 1 to about 5 carbon atoms; “n” is an integer from about 1 to about 30;
wherein the blend:surfactant ratio is less than or equal to 0.8; and
(c) from about 0.1 to about 5%, by weight of the composition, of water;
wherein the cleaning composition is in the form of a microemulsion and is dilutable with water by an amount of at least 99 parts water to 1 part said cleaning composition without phase separation.

18. A method of cleaning a surface comprising:
(a) providing the cleaning composition of claim 1;
(b) diluting the cleaning composition by an amount equal to or greater than 99 parts water to 1 part cleaning composition;
(c) contacting the cleaning composition with a surface having one or more contaminants on it; and
(d) removing the used cleaning composition from the surface.

19. The method of claim 18 wherein the blend of dibasic esters comprises:
(i) from about 5-25%, by weight of the blend, a first dibasic ester of formula: 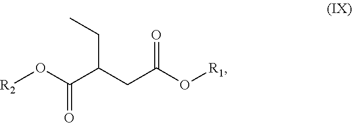
(ii) from about 70-95%, by weight of the blend, a second dibasic ester of formula: 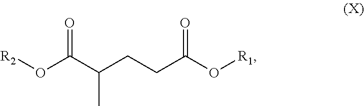
and
(iii) from about 0-5%, by weight of the blend, a third dibasic ester of formula: 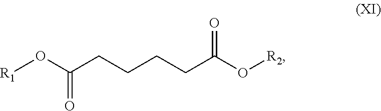
wherein R₁ and R₂ are individually selected from branched, linear or cyclic C₁-C₁₀ hydrocarbon groups.

20. The method of claim 18 wherein the blend of dibasic esters comprises:
(i) from about 20-28%, by weight of the blend, a first dibasic ester of formula: 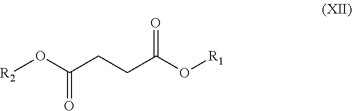
(ii) from about 59-67%, by weight of the blend, a second dibasic ester of formula: 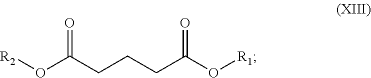
and
(iii) from about 9-17%, by weight of the blend, a third dibasic ester of formula: 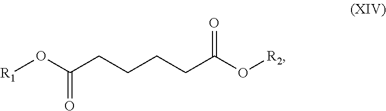
wherein R₁ and R₂ are individually selected from branched, linear or cyclic C₁-C₁₀ hydrocarbon groups.

21. A method of cleaning a surface comprising:
(a) providing the cleaning composition of claim 17;
(b) contacting the cleaning composition with a surface having one or more contaminants on it; and
(c) removing the used cleaning composition from the surface.

22. An environmentally-friendly, readily biodegradable, low VOC cleaning composition comprising:
(a) a blend of dibasic esters selected from the group consisting of dialkyl methylglutarate, dialkyl adipate, dialkyl ethylsuccinate, dialkyl succinate, dialkyl glutarate and any combination thereof;
(b) a co-solvent, the blend of dibasic esters and co-solvent together comprising a solvent blend;
(c) at least one nonionic surfactant,
wherein the solvent blend:surfactant ratio (by weight) is less than or equal to 2.3:1;
wherein the cleaning composition is in the form of a microemulsion when mixed in water and is dilutable with water by an amount of at least 99 parts water to 1 part said cleaning composition without phase separation.

23. The cleaning composition of claim 22 wherein the co-solvent is selected from the group consisting of saturated hydrocarbon solvents, glycol ethers, fatty acid methyl esters, aliphatic hydrocarbons solvents, acyclic hydrocarbons solvents, halogenated solvents, aromatic hydrocarbon solvents, cyclic terpenes, unsaturated hydrocarbon solvents, halocarbon solvents, polyols, ethers, esters of a glycol ether, alcohols, ketones, and any combination thereof.

24. The cleaning composition of claim 22 wherein the blend:surfactant ratio (by weight) is less than or equal to 1.5:1.
